(19) United States
(12) Patent Application Publication
(10) Pub. No.: US 2007/0076152 A1
(43) Pub. Date: Apr. 5, 2007

(54) LIQUID CRYSTAL DISPLAY DEVICE

(76) Inventors: Hideki Ito, Saitama-shi (JP); Yuuzo Hisatake, Fukaya-shi (JP); Akio Murayama, Fukaya-shi (JP); Chigusa Tago, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/537,860

(22) Filed: Oct. 2, 2006

(30) Foreign Application Priority Data
Oct. 4, 2005 (JP) 2005-291270

(51) Int. Cl. G02F 1/1335

(52) U.S. Cl. 349/117

(57) ABSTRACT

A circular polarizer structure, which is included in a liquid crystal display device, includes a uniaxial third retardation plate for optical compensation of the circular polarizer structure between a first polarizer plate and a first retardation plate, the uniaxial third retardation plate having a refractive index anisotropy of nx≃nz>ny. A circular analyzer structure includes a uniaxial fourth retardation plate for optical compensation of the circular analyzer structure between a second polarizer plate and a second retardation plate, the uniaxial fourth retardation plate having a refractive index anisotropy of nx≃nz>ny. A variable retarder structure includes a fifth retardation plate for optical compensation of the variable retarder structure between the first retardation plate and the second retardation plate, the fifth retardation plate having a refractive index anisotropy of nx≃ny>nz.

### CROSS-REFERENCE TO RELATED APPLICATIONS

This application is based upon and claims the benefit of priority from prior Japanese Patent Application No. 2005-291270, filed Oct. 4, 2005, the entire contents of which are incorporated herein by reference.

### BACKGROUND OF THE INVENTION

1. Field of the Invention

The present invention relates generally to a liquid crystal display device, and more particularly to a circular-polarization-based vertical-alignment-mode liquid crystal display device.

2. Description of the Related Art

A liquid crystal display device has various features such as thickness in size, light weight, and low power consumption. The liquid crystal display device is applied to various uses, e.g. OA equipment, information terminals, timepieces, and TVs. In particular, a liquid crystal display device comprising thin-film transistors (TFTs) has high responsivity and, therefore, it is used as a monitor of a mobile TV, a computer, etc., which displays a great deal of information.

In recent years, with an increase in quantity of information, there has been a strong demand for higher image definition and higher display speed. Of these, the higher image definition is realized, for example, by making finer the array structure of the TFTs.

On the other hand, in order to increase the display speed, consideration has been given to, in place of conventional display modes, an OCB (Optically Compensated Birefringence) mode, a VAN (Vertically Aligned Nematic) mode, a HAN (Hybrid Aligned Nematic) mode and a π alignment mode, which use nematic liquid crystals, and an SSFLC (Surface-Stabilized Ferroelectric Liquid Crystal) mode and an AFLC (Anti-Ferroelectric Liquid Crystal) mode, which use smectic liquid crystals.

Of these display modes, the VAN mode, in particular, has a higher response speed than in the conventional TN (Twisted Nematic) mode. An additional feature of the VAN mode is that a rubbing process, which may lead to a defect such as an electrostatic breakage, can be made needless by vertical alignment. Particular attention is drawn to a multi-domain VAN mode (hereinafter referred to as “MVA mode”) in which a viewing angle can be increased relatively easily.

A circular-polarization-based MVA mode has been studied in order to solve the problem that the transmittance is lower than in the TN mode. The above-described problem is solved by using a polarizer plate including a uniaxial ¼ wavelength plate, which provides a phase difference of ¼ wavelength between light rays with a predetermined wavelength, which pass through a fast axis and a slow axis thereof, that is, by using a circular polarizer plate.

However, the conventional circular-polarization-based MVA mode has such a problem that viewing angle characteristics are narrow. In order to solve this problem, various studies have been made. For example, Jpn. Pat. Appln. KOKAI Publication No. 2005-37784 proposes a liquid crystal display device wherein a retardation plate (C-plate), which is an optically negative uniaxial medium, is provided in order to compensate the viewing angle dependency of phase difference in the normal direction of a liquid crystal layer. In addition, between a retardation plate and a polarizer plate which are located on the light incidence side, a uniaxial retardation plate having a refractive index ellipsoid of nx>ny=nz, which compensates viewing angle characteristics of the polarizer plate, is disposed such that the slow axis of the uniaxial retardation plate becomes substantially parallel to the transmission axis of the polarizer plate.

### BRIEF SUMMARY OF THE INVENTION

The object of the invention is to provide a liquid crystal display device that can improve viewing angle characteristics and can reduce cost.

According to a first aspect of the invention, there is provided a liquid crystal display device which is configured such that a dot-matrix liquid crystal cell, in which a liquid crystal layer is held between two electrode-equipped substrates, is disposed between a first polarizer plate that is situated on a light source side and a second polarizer plate that is situated on an observer side, a uniaxial first retardation plate is disposed between the first polarizer plate and the liquid crystal cell such that a slow axis of the first retardation plate forms an angle of about 45° with respect to an absorption axis of the first polarizer plate, and a uniaxial second retardation plate is disposed between the second polarizer plate and the liquid crystal cell such that a slow axis of the second retardation plate forms an angle of about 45° with respect to an absorption axis of the second polarizer plate, the liquid crystal display device comprising: a circular polarizer structure including the first polarizer plate and the first retardation plate; a variable retarder structure including the liquid crystal cell; and a circular analyzer structure including the second polarizer plate and the second retardation plate, wherein the variable retarder structure has an optically positive normal-directional phase difference in a black display state, each of the first retardation plate and the second retardation plate is a ¼ wavelength plate which provides a phase difference of a ¼ wavelength between light rays of a predetermined wavelength that pass through a fast axis and the slow axis thereof, the circular polarizer structure includes a first optical compensation layer which is disposed for optical compensation of the circular polarizer structure between the first polarizer plate and the first retardation plate, the first optical compensation layer including a third retardation plate with a refractive index anisotropy of nx≃nz>ny, the third retardation plate being disposed such that a slow axis thereof is substantially perpendicular to the absorption axis of the first polarizer plate, the circular analyzer structure includes a second optical compensation layer which is disposed for optical compensation of the circular analyzer structure between the second polarizer plate and the second retardation plate, the second optical compensation layer including a fourth retardation plate with a refractive index anisotropy of nx≃nz>ny, the fourth retardation plate being disposed such that a slow axis thereof is substantially perpendicular to the absorption axis of the second polarizer plate, and the variable retarder structure includes a third optical compensation layer which is disposed for optical compensation of the variable retarder structure between the first retardation plate and the second retardation plate, the third optical compensation layer including a fifth retardation plate with a refractive index anisotropy of nx≃ny>nz.

According to a second aspect of the invention, there is provided a liquid crystal display device including a uniaxial first retardation plate, which is disposed between a dot-matrix liquid crystal cell, in which a liquid crystal layer is held between two electrode-equipped substrates and a reflective layer is provided in each of pixels, and a polarizer plate such that a slow axis of the first retardation plate forms an angle of about 45° with respect to an absorption axis of the polarizer plate, the liquid crystal display device comprising: a circular polarizer/analyzer structure including the polarizer plate and the first retardation plate; and a variable retarder structure including the liquid crystal cell, wherein the variable retarder structure has an optically positive normal-directional phase difference in a black display state, the first retardation plate is a ¼ wavelength plate which provides a phase difference of a ¼ wavelength between light rays of a predetermined wavelength that pass through a fast axis and a slow axis thereof, the circular polarizer/analyzer structure includes a first optical compensation layer which is disposed for optical compensation of the circular polarizer/analyzer structure between the polarizer plate and the first retardation plate, the first optical compensation layer including a second retardation plate with a refractive index anisotropy of nx≃nz>ny, the second retardation plate being disposed such that a slow axis thereof is substantially perpendicular to the absorption axis of the polarizer plate, and the variable retarder structure includes a second optical compensation layer which is disposed for optical compensation of the variable retarder structure between the first retardation plate and the liquid crystal cell, the second optical compensation layer including a third retardation plate with a refractive index anisotropy of nx≃ny>nz.

The present invention can provide a liquid crystal display device that can improve viewing angle characteristics and can reduce cost.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A schematically shows an example of the cross-sectional structure of a liquid crystal display device according to a first embodiment of the present invention;

FIG. 1B schematically shows an example of the cross-sectional structure of a liquid crystal display device according to Modification 1 of the first embodiment of the invention;

FIG. 1C schematically shows an example of the cross-sectional structure of a liquid crystal display device according to Modification 2 of the first embodiment of the invention;

FIG. 1D schematically shows an example of the cross-sectional structure of a liquid crystal display device according to a second embodiment of the invention;

FIG. 1E schematically shows an example of the cross-sectional structure of a liquid crystal display device according to a third embodiment of the invention;

FIG. 2 is a view for explaining a refractive index ellipsoid of a first retardation plate and a second retardation plate, which are applicable to the liquid crystal display device according to the embodiment;

FIG. 3 is a view for explaining a refractive index ellipsoid of a third retardation plate and a fifth retardation plate, which are applicable to the liquid crystal display device according to the embodiment;

FIG. 4 is a view for explaining a refractive index ellipsoid of a fifth retardation plate, which is applicable to the liquid crystal display device according to the embodiment;

FIG. 5 is a view for explaining a compensation principle of contrast/viewing angle characteristics of the liquid crystal display device according to the embodiment; and

FIG. 6 shows a measurement result of isocontrast curves of the liquid crystal display device according to the embodiment.

### DETAILED DESCRIPTION OF THE INVENTION

A liquid crystal display device according to an embodiment of the present invention will now be described with reference to the accompanying drawings.

(First Embodiment)

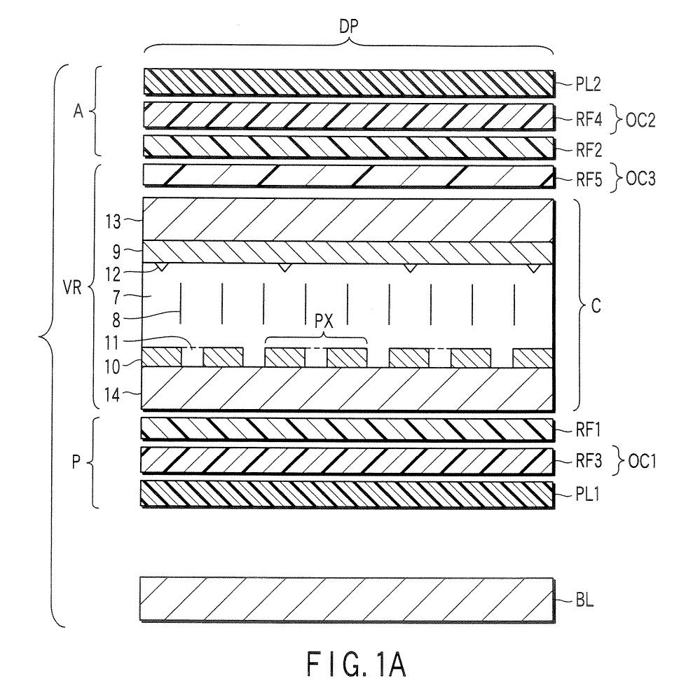

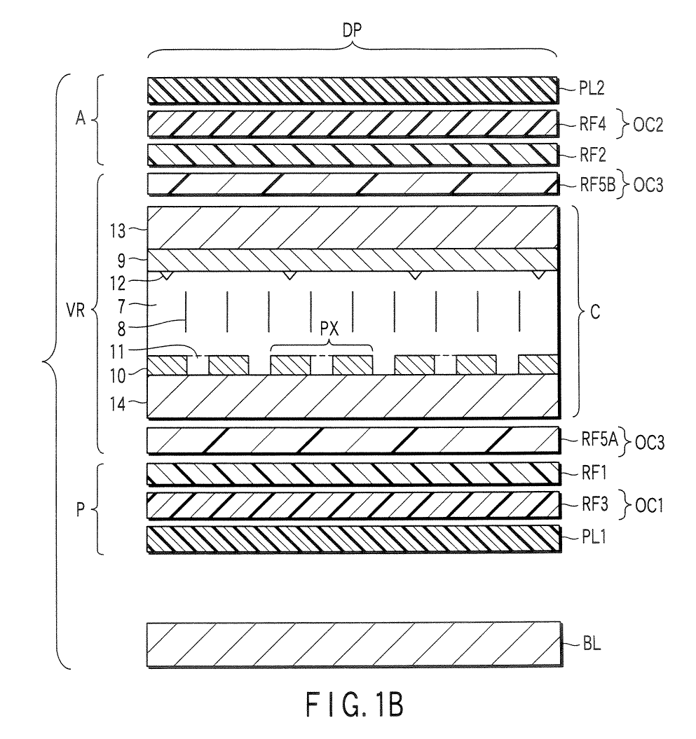

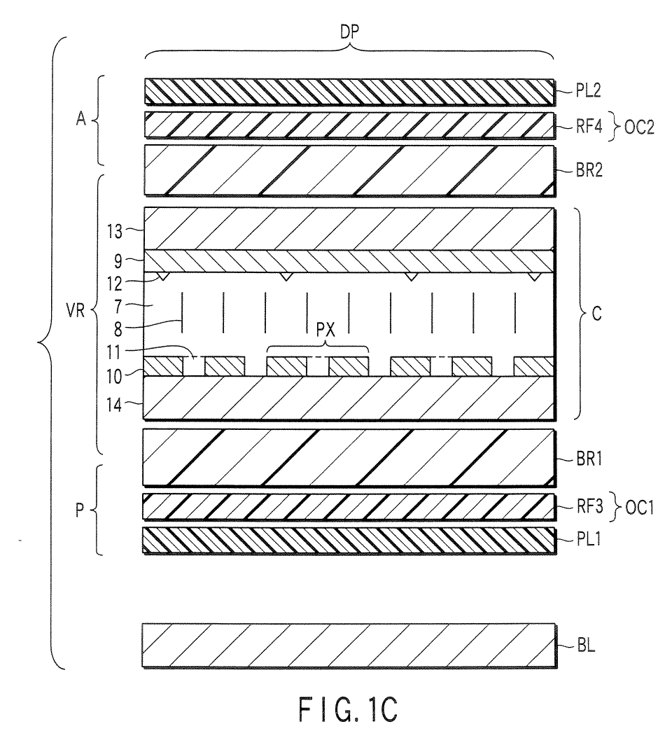

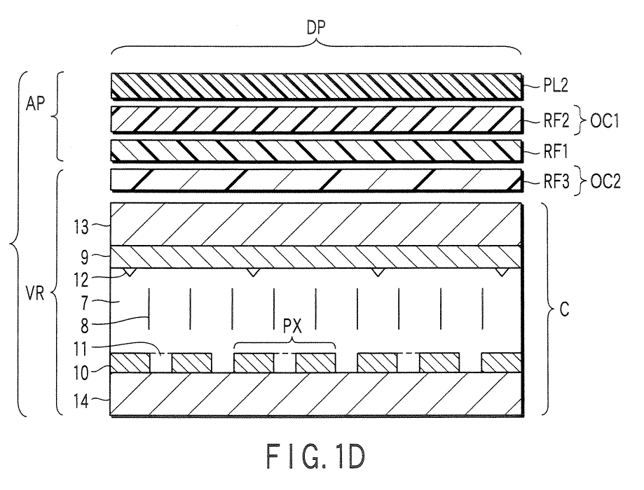

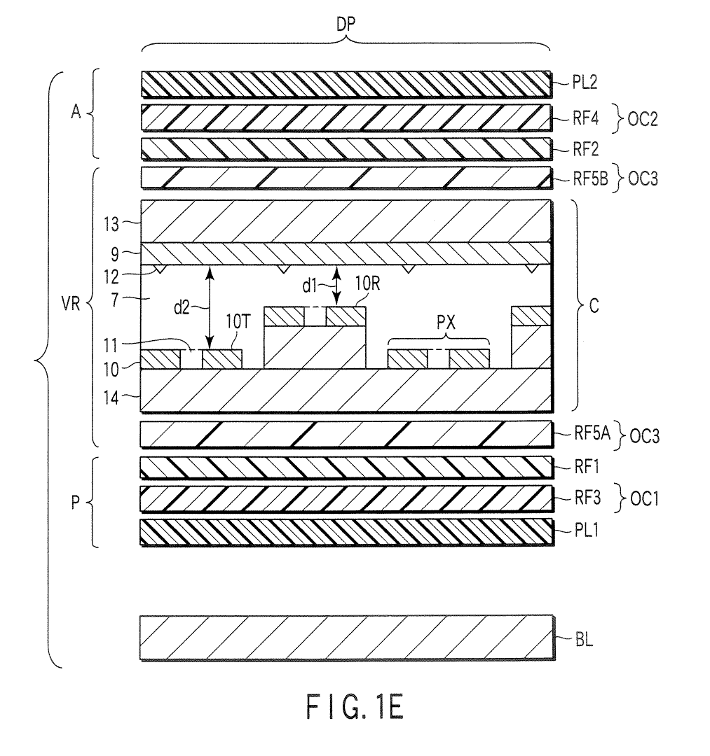

FIG. 1A schematically shows the structure of a transmissive liquid crystal display device according a first embodiment of the invention. As is shown in FIG. 1A, the liquid crystal display device is a liquid crystal display device of a circular-polarization-based vertical alignment mode in which liquid crystal molecules in each pixel are aligned substantially vertical to the major surface of the substrate in a voltage-off state. The liquid crystal display device comprises a circular polarizer structure P, a variable retarder structure VR and a circular analyzer structure A.

The variable retarder structure VR includes a dot-matrix liquid crystal cell C in which a liquid crystal layer is held between two electrode-equipped substrates. Specifically, this liquid crystal cell C is an MVA mode liquid crystal cell, and a liquid crystal layer 7 is held between an active matrix substrate 14 and a counter-substrate 13. The gap between the active matrix substrate 14 and counter-substrate 13 is kept constant by a spacer (not shown). The liquid crystal cell C includes a display region DP for displaying an image. The display region DP is composed of pixels PX that are arranged in a matrix.

The active matrix substrate 14 is configured to include an insulating substrate with light transmissivity, such as a glass substrate. One major surface of the insulating substrate is provided with, e.g. various lines such as scan lines and signal lines, and switching elements provided near intersections of the scan lines and signal lines. A description of these elements is omitted since they are not related to the advantageous effect of the present invention. Pixel electrodes 10 are provided on the active matrix substrate 14 in association with the respective pixels PX. The surfaces of the pixel electrodes 10 are covered with an alignment film.

The various lines, such as scan lines and signal lines, are formed of aluminum, molybdenum, copper, etc. The switching element is a thin-film transistor (TFT) including a semiconductor layer of, e.g. amorphous silicon or polysilicon, and a metal layer of, e.g. aluminum, molybdenum, chromium, copper or tantalum. The switching element is connected to the scan line, signal line and pixel electrode 10. On the active matrix substrate 14 with this structure, a voltage can selectively be applied to a desired one of the pixel electrodes 10.

The pixel electrode 10 is formed of an electrically conductive material with light transmissivity, such as indium tin oxide (ITO). The pixel electrode 10 is formed by providing a thin film using, e.g. sputtering, and then patterning the thin film using a photolithography technique and an etching technique.

The alignment film is formed of a thin film of a resin material with light transmissivity, such as polyimide. In this embodiment, the alignment film is not subjected to a rubbing process, and liquid crystal molecules 8 are vertically aligned.

The counter-substrate 13 is configured to include an insulating substrate with light transmissivity, such as a glass substrate. A common electrode 9 is provided on one major surface of the insulating substrate. The surface of the common electrode 9 is covered with an alignment film.

The common electrode 9, like the pixel electrode 10, is formed of an electrically conductive material with light transmissivity, such as ITO. The alignment film, like the alignment film on the active matrix substrate 14, is formed of a resin material with light transmissivity, such as polyimide. In this embodiment, the common electrode 9 is formed as a planar continuous film that faces all the pixel electrodes with no discontinuity.

When the present display device is constructed as a color liquid crystal device, the liquid crystal cell C includes a color filter layer. The color filter layer comprises color layers of, e.g. three colors of blue, green and red. The color filter layer may be provided between the insulating substrate of the active matrix substrate 14 and the pixel electrode 10 with a COA (Color-filter On Array) structure, or may be provided on the counter-substrate 13.

If the COA structure is adopted, the color filter layer is provided with a contact hole, and the pixel electrode 10 is connected to the switching element via the contact hole. The COA structure is advantageous in that high-precision alignment using, e.g. alignment marks is needless when the liquid crystal cell C is to be formed by attaching the active matrix substrate 14 and counter-substrate 13.

The circular polarizer structure P includes a first polarizer plate PL1 that is located on a light source side of the liquid crystal cell C, that is, on a backlight unit BL side, and a uniaxial first retardation plate RF1 that is disposed between the first polarizer plate PL1 and liquid crystal cell C. The circular analyzer structure A includes a second polarizer plate PL2 that is disposed on the observation side of the liquid crystal cell C, and a uniaxial second retardation plate RF2 that is disposed between the second polarizer plate PL2 and liquid crystal cell C.

Each of the first polarizer plate PL1 and second polarizer plate PL2 has a transmission axis and an absorption axis, which are substantially perpendicular to each other in the plane thereof. The first retardation plate PL1 and second retardation plate PL2 are disposed such that their transmission axes intersect at right angles with each other. Each of the first polarizer plate PL1 and second polarizer plate PL2 is configured such that a polarizer formed of, e.g. polyvinyl alcohol is held between base films of, e.g. triacetate cellulose (TAC).

Each of the first retardation plate RF1 and second retardation plate RF2 is a uniaxial ¼ wavelength plate that has, within its plane, a fast axis and a slow axis, which are substantially perpendicular to each other, and provides a phase difference of ¼ wavelength (i.e. in-plane phase difference of 140 nm) between light rays with a predetermined wavelength (e.g. 550 nm), which pass through the fast axis and slow axis. The first retardation plate RF1 and second retardation plate RF2 are disposed such that their slow axes intersect at right angles with each other. The first retardation plate RF1 is disposed such that its slow axis forms an angle of about 45° with respect to the absorption axis of the first polarizer plate PL1. Similarly, the second retardation plate RF2 is disposed such that its slow axis forms an angle of about 45° with respect to the absorption axis of the second polarizer plate PL2.

The liquid crystal display device with this structure, which includes, in particular, a transmission part that can pass backlight in at least a part of the pixel PX or in at least a part of the display region DP, is constructed by successively stacking the backlight unit BL, circular polarizer structure P, variable retarder structure VR and circular analyzer structure A.

The liquid crystal display device with this structure includes a first optical compensation layer OC1, which is disposed for optical compensation of the circular polarizer structure P (including the base films of the first polarizer plate PL1) between the first polarizer plate PL1 and first retardation plate RFl; a second optical compensation layer OC2, which is disposed for optical compensation of the circular analyzer structure A (including the base films of the second polarizer plate PL2) between the second polarizer plate PL2 and second retardation plate RF2; and a third optical compensation layer OC3, which is disposed for optical compensation of the variable retarder structure VR between the first retardation plate RF1 and second retardation plate RF2.

Specifically, the first optical compensation layer OC1 compensates the viewing angle characteristics of the circular polarizer structure P so that emission light from the circular polarizer structure P may become substantially circularly polarized light, regardless of the direction of emission. The second optical compensation layer OC2 compensates the viewing angle characteristics of the circular analyzer structure A so that emission light from the circular analyzer structure A may become substantially circularly polarized light, regardless of the direction of emission. The third optical compensation layer OC3 compensates the viewing angle characteristics of the phase difference of the liquid crystal cell C in the variable retarder structure VR (i.e. an optically positive normal-directional phase difference of the liquid crystal layer 7 in the state in which the liquid crystal molecules 8 are aligned substantially vertical to the major surface of the substrate, that is, in the state of black display).

The first optical compensation layer OC1 includes an optically uniaxial third retardation plate (negative A-plate) RF3 which has a refractive index anisotropy of nx≃nz>ny. The third retardation plate RF3 is disposed such that its slow axis is substantially perpendicular to the absorption axis of the first polarizer plate PL1.

The second optical compensation layer OC2 includes an optically uniaxial fourth retardation plate (negative A-plate) RF4 which has a refractive index anisotropy of nx≃nz>ny. The fourth retardation plate RF4 is disposed such that its slow axis is substantially perpendicular to the absorption axis of the second polarizer plate PL2 and is substantially perpendicular to the slow axis of the third retardation plate RF3.

The third optical compensation layer OC3 includes an optically uniaxial fifth retardation plate (negative C-plate) RF5 which has a refractive index anisotropy of nx≃ny>nz. In the example shown in FIG. 1A, the fifth retardation plate RFS is disposed between the liquid crystal cell C and the second retardation plate RF2. Alternatively, the fifth retardation plate RFS may be disposed between the liquid crystal cell C and the first retardation plate RF1.

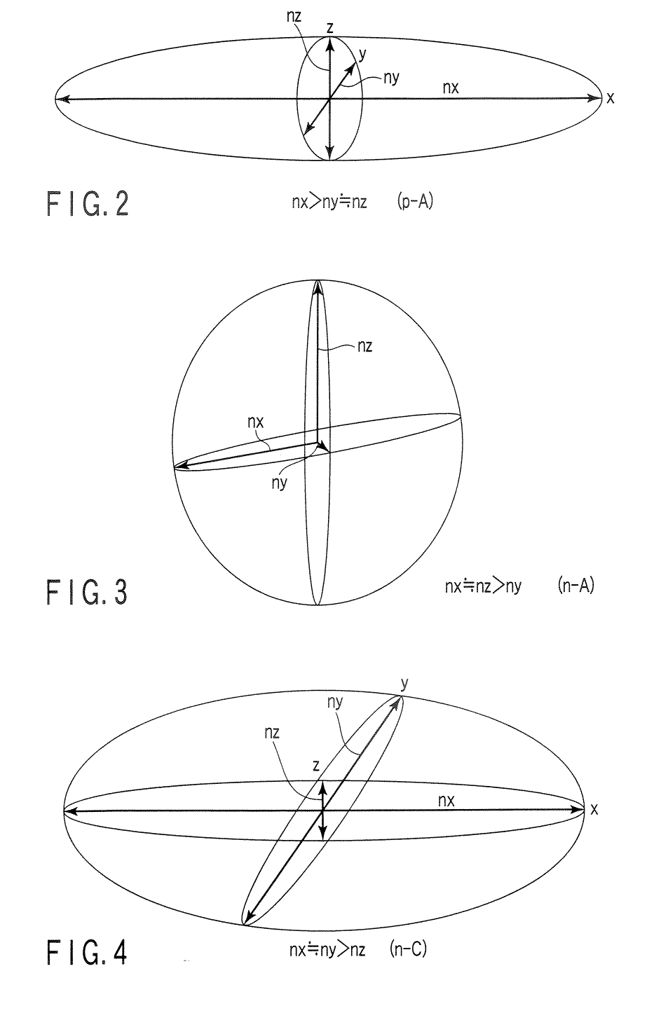

A retardation plate that is applicable to the first retardation plate RF1 and second retardation plate RF2 should have a refractive index ellipsoid (nx>ny≃nz) (positive A-plate) as shown in FIG. 2. Each of the first retardation plate RF1 and second retardation plate RF2 has an in-plane phase difference of, e.g. 135 nm and a normal-directional phase difference of, e.g. 135 nm.

A retardation plate that is applicable to the third retardation plate RF3 and fourth retardation plate RF4 should have a refractive index ellipsoid (nx≃nz>ny) (negative A-plate) as shown in FIG. 3. As regards the third retardation plate RF3 and fourth retardation plate RF4, if the thickness of each of these retardation plates is t, the in-plane phase difference is defined by (nx−ny)×t and the normal-directional phase difference is defined by (nz−ny)×t, then the relationship, nx≃nz, is established. Thus, the in-plane phase difference and normal-directional phase difference are substantially equal. In order to obtain such a configuration that the viewing angle with a contrast ratio of 10:1 or more becomes ±80° or more in almost all azimuth directions, the in-plane phase difference (or normal-directional phase difference) of the third retardation plate RF3 and fourth retardation plate RF4 is set to be greater than 30 nm and less than 160 nm. In this embodiment, each of the third retardation plate RF3 and fourth retardation plate RF4 has an in-plane phase difference of, e.g. 130 nm and a normal-directional phase difference of, e.g. 130 nm.

A retardation plate that is applicable to the fifth retardation plate RF5 should have a refractive index ellipsoid (nx≃ny>nz) (negative C-plate) as shown in FIG. 4. As regards the fifth retardation plate RFS, in the case where the thickness thereof is t and the normal-directional phase difference is defined by (nz−ny)×t, in order to obtain such a configuration that the viewing angle with a contrast ratio of 10:1 or more becomes ±80° or more in almost all azimuth directions, the normal-directional phase difference of the fifth retardation plate RFS is set to be greater than −180 and less than −145. In this embodiment, the fifth retardation plate RFS has a normal-directional phase difference of, e.g. −160 nm.

In FIG. 2 to FIG. 4, nx and ny designate refractive indices in two mutually perpendicular directions (X axis and Y axis) in the major surface of each retardation plate, and nz indicates the refractive index in the normal direction (Z axis) to the major surface of the retardation plate.

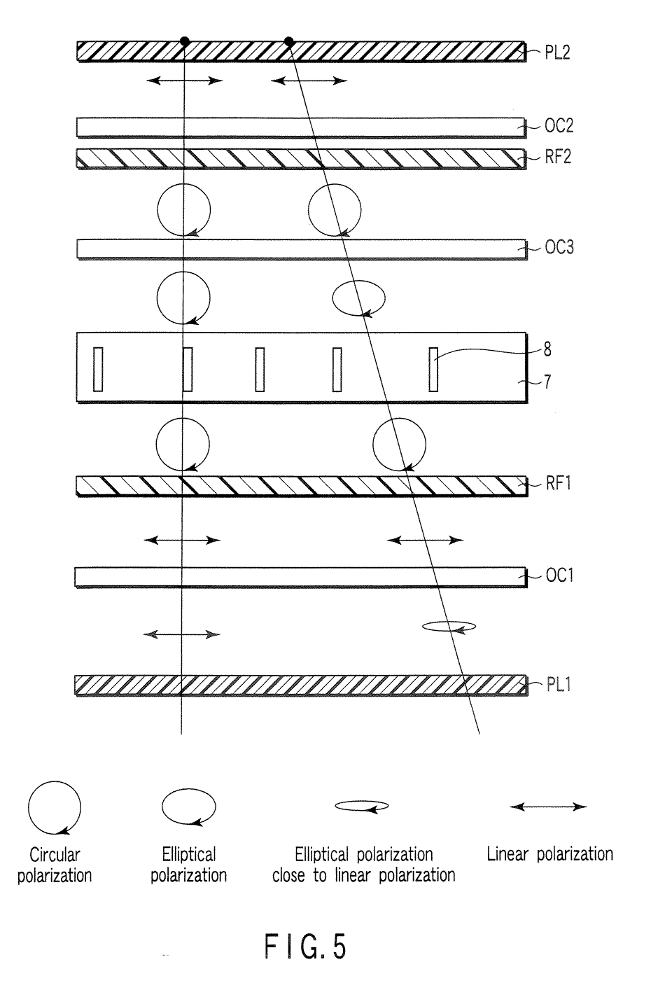

FIG. 5 is a conceptual view of the polarization state in respective optical paths, illustrating the optical principle of the viewing angle characteristics of the liquid crystal display device shown in FIG. 1A.

The liquid crystal display device uses the third optical compensation layer OC3 including the optically negative fifth retardation plate RF5, which is made to function as a negative retardation plate along with the separately provided first retardation plate RF1 and second retardation plate RF2. Thereby, the viewing angle dependency of the optically positive phase difference (normal-directional phase difference) in the normal direction of the liquid crystal layer 7, whose Δn·d is 280 nm or more, is compensated. The third optical compensation layer OC3 with this compensation function is provided between the first retardation plate RF1 and second retardation plate RF2. Thus, if light that is incident on the first retardation plate RF1 and second retardation plate RF2 is linearly polarized light, the light that is emitted from the first retardation plate RF1 and second retardation plate RF2 becomes substantially circularly polarized light, regardless of the emission angle or emission direction.

Accordingly, in the case where the third optical compensation layer OC3 is situated between the liquid crystal layer 7 and second retardation plate RF2, the light that is incident on the liquid crystal layer 7 becomes circularly polarized light, irrespective of the incidence angle or incidence direction. Even if the circularly polarized light becomes elliptically polarized light due to the normal-directional phase difference of the liquid crystal layer 7, the elliptically polarized light is restored to the circularly polarized light by the function of the third optical compensation layer OC3. Thus, the light that is incident on the second retardation plate RF2 disposed on the third optical compensation layer OC3 becomes circularly polarized light, irrespective of the incidence angle or incidence direction. Therefore, good display characteristics can be obtained regardless of the viewing direction.

In the case where the third optical compensation layer OC3 is situated between the liquid crystal layer 7 and first retardation plate RF1, the light that is incident on the third optical compensation layer OC3 becomes circularly polarized light, irrespective of the incidence angle or incidence direction. Even if the circularly polarized light becomes elliptically polarized light due to the normal-directional phase difference of the third optical compensation layer OC3, the elliptically polarized light is restored to the circularly polarized light by the function of the liquid crystal layer 7. Thus, the light that is incident on the second retardation plate RF2 disposed on the liquid crystal layer 7 becomes circularly polarized light, irrespective of the incidence angle or incidence direction. Therefore, good display characteristics can be obtained irrespective of the viewing direction, as in the case where the third optical compensation layer OC3 is disposed between the liquid crystal layer 7 and second retardation plate RF2.

On the other hand, in the conventional circular-polarization-based MVA mode liquid crystal display device, a pair of biaxial ¼ wavelengths plates each having a refractive index anisotropy of nx>ny>nz are disposed such that their slow axes are perpendicular to each other. These ¼ wavelength plates have functions of simultaneously realizing the functions of the third optical compensation layer OC3, the first retardation plate RF1 and second retardation plate RF2, which are used in the above-described embodiment However, if such a condition is set as to also compensate the normal-directional phase difference of the liquid crystal layer 7, the light emerging from the biaxial ¼ wavelength plate necessarily becomes elliptically polarized light. Consequently, the light emerging from the biaxial ¼ wavelength plate becomes polarized light with a polarization direction in the major axis of the ellipsoid. As a result, the transmittance characteristics depend on the alignment direction of liquid crystal molecules, and a sufficient viewing angle compensation effect cannot be obtained depending on directions.

By contrast, in the liquid crystal display device structure of this embodiment, polarized light, which is incident on the liquid crystal layer 7 and third optical compensation layer OC3 that compensates the normal-directional phase difference of the liquid crystal layer 7, is circularly polarized light which has no directional polarity. Therefore, the above-described problem does not occur, and the compensation effect, which does not depend on the direction of alignment of liquid crystal molecules, can be obtained.

In order to sufficiently obtain the above-described advantageous effect, the first optical compensation layer OC1, which comprises such optically uniaxial retardation plates as to compensate the viewing-angle characteristics of the first retardation plate RF1 and first polarizer plate PL1, may be disposed between the first retardation plate RF1 and first polarizer plate PL1, which are located on the light incidence side. In addition, the second optical compensation layer OC2, which comprises such optically uniaxial retardation plates as to compensate the viewing-angle characteristics of the second retardation plate RF2 and second polarizer plate PL2, may be disposed between the second retardation plate RF2 and second polarizer plate PL2, which are located on the emission side. Thereby, better viewing-angle characteristics can be obtained.

In the liquid crystal display device of the above-described embodiment, the multi-domain vertical alignment mode, in which liquid crystal molecules in the pixel are controlled and oriented in at least two directions in a voltage-on state, is applied to the liquid crystal cell C. In this mode, it is preferable to form such a domain that the orientation direction of liquid crystal molecules 8 in the pixel PX in a voltage-on state is substantially parallel to the absorption axis or transmission axis of the first polarizer plate PL1 in at least half the opening region of each pixel PX.

This orientation control can be realized by providing a protrusion 12 for forming the multi-domain structure in the pixel PX, as shown in FIG. 1A. The orientation control can also be realized by forming a slit 11 for forming the multi-domain structure in at least one of the pixel electrode 10 and counter-electrode 9 which are disposed in each pixel PX. Further, the orientation control can be realized by providing alignment films, which are subjected to an alignment process of, e.g. rubbing, for forming the multi-domain structure, on those surfaces of the active matrix substrate 14 and counter-substrate 13, which sandwich the liquid crystal layer 7. Needless to say, at least two of the protrusion 12, slit 11 and orientation film that is subjected to the alignment process may be combined.

As has been described above, in the linear-polarization-based MVA mode liquid crystal display device, a maximum transmittance is obtained when the alignment direction of liquid crystal molecules is at an angle of π/4 (rad) with respect to the transmission axis of the polarizer plate. Thus, in the case of the linear-polarization-based MVA mode liquid crystal display device, the multi-domain structure (protrusion or slit) is provided in the pixel or the alignment film is subjected to an alignment process such as rubbing, so that the alignment direction of liquid crystal molecules in the pixel in the voltage-off state may become at an angle of π/4 (rad) with respect to the transmission axis of the polarizer plate.

By contrast, circular-polarization-based MVA mode liquid crystal display device, the transmittance does not depend on the orientation direction of liquid crystal molecules in the pixel in the voltage-on state. Thus, if a phase difference of ½ wavelength is obtained by the liquid crystal layer 7 and fifth retardation plate RF5, excellent transmittance characteristics can be obtained regardless of the liquid crystal molecule orientation direction.

In the multi-domain vertical alignment mode, the multi-domain structure is constituted so as to obtain the above-mentioned phase difference of ½ wavelength regardless of the light incidence angle. However, depending on the incidence angle or the tilt angle of liquid crystal molecules, there may be a case where the orientation dependence of phase difference cannot be compensated by the multi-domain effect. In order to minimize this problem, the liquid crystal molecule orientation direction should be made parallel to the transmission axis or absorption axis of the polarizer plate. The reason is that when the light that emerges from the liquid crystal layer 7 and fifth retardation plate RF5 becomes elliptically polarized light, and not circularly polarized light, the major-axis direction of the elliptically polarized light becomes parallel to the optical axis (transmission axis and absorption axis) of the second polarizer plate PL2 that is the analyzer.

Preferably, in the liquid crystal display device according to the present embodiment, the first retardation plate RF1 and the second retardation plate RF2 should be formed of a resin that has a retardation value, which hardly depends on an incidence light wavelength in a plane thereof, such as ARTON resin, polyvinyl alcohol resin, ZEONOR resin, or triacetyl cellulose resin. Alternatively, the first retardation plate RF1 and second retardation plate RF2 should preferably be formed of a resin that has a retardation value, which is about ¼ of incident light wavelength in a plane thereof regardless of incident light wavelength, such as denatured polycarbonate resin. Polarization with less wavelength dispersion dependency of incident light can be obtained by using, not a material such as polycarbonate which has a greater retardation in the shorter-wavelength side, but a material with a constant refractive index in all wavelength ranges or a material such as denatured polycarbonate which always has a retardation value of ¼ wavelength regardless of incident light wavelength.

The third retardation plate RF3 and fourth retardation plate RF4 should preferably be formed of one of a norbornene resin, a denatured polycarbonate resin and a discotic liquid crystal polymer.

The fifth retardation plate RF5 should preferably be formed of one of a chiral nematic liquid crystal polymer, a cholesteric liquid crystal polymer and a discotic liquid crystal polymer.

In the present embodiment, as described above, the fifth retardation plate RFS is employed in order to compensate the normal-directional phase difference of the liquid crystal layer 7. The phase difference of the liquid crystal layer 7, which is to be compensated, has wavelength dispersion. In order to compensate the phase difference of the liquid crystal layer 7 including the wavelength dispersion, a more excellent compensation effect can be obtained if the fifth retardation plate RF5 has similar wavelength dispersion. It is thus preferable to form the fifth retardation plate RF5 of the above-mentioned liquid crystal polymer.

As has been described above, according to the first embodiment, the viewing angle characteristics can be improved without using a high-cost retardation plate.

(First Embodiment; Modification 1)

In Modification 1 of the first embodiment, the liquid crystal display device may include a third optical compensation layer OC3 which is divided into two segments with separated functions. Specifically, as shown in FIG. 1B, the fifth retardation plate RF5, which constitutes the third optical compensation layer OC3, is functionally divided into a first segment layer RF5A, which is disposed between the first retardation plate RF1 and the liquid crystal cell C, and a second segment layer RF5B, which is disposed between the second retardation plate RF2 and the liquid crystal cell C. In this structure, the total thickness of the first segment layer RF5A and second segment layer RF5B is set to be, for instance, T, which is the thickness of the functional layer that functions as the fifth retardation plate RF5. Thereby, the same function as with the liquid crystal display device shown in FIG. 1A is realized. The ratio between the thickness of the first segment layer RF5A and the thickness of the second segment layer RF5B may arbitrarily be set. For example, if the fifth retardation plate RF5 needs to have a normal-directional phase difference of −160 nm, each of the first segment layer RF5A and second segment layer RF5B is configured to have a normal-directional phase difference of −80 nm. However, the setting of the ratio is not limited to this example if the total normal-directional phase difference of the first segment layer RF5A and second segment layer RF5B becomes −160 nm.

In Modification 1, too, the viewing angle characteristics can be improved without using a high-cost retardation plate.

(First Embodiment; Modification 2)

In Modification 2 of the first embodiment, which is a further modification of Modification 1 shown in FIG. 1B, the first segment layer RF5A and first retardation plate RF1 may be formed of a single biaxial retardation plate BR1, as shown in FIG. 1C. The single biaxial retardation plate BR1 has such a total optical function as to impart a phase difference of ¼ wavelength between light rays of a predetermined wavelength that pass through its fast axis and slow axis, and to be equivalent to a biaxial refractive index anisotropy of nx>ny>nz. The retardation plate BR1 may be disposed between the liquid crystal cell C and first polarizer plate PL1.

Similarly, the second segment layer RF5B and second retardation plate RF2 may be formed of a single biaxial retardation plate BR2. The single biaxial retardation plate BR2 has such a total optical function as to impart a phase difference of ¼ wavelength between light rays of a predetermined wavelength that pass through its fast axis and slow axis, and to be equivalent to a biaxial refractive index anisotropy of nx>ny>nz. The retardation plate BR2 may be disposed between the liquid crystal cell C and second polarizer plate PL2.

In order to realize the same function as the first retardation plate RF1 and second retardation plate RF2, each of the retardation plates BR1 and BR2 has a function of a ¼ wavelength plate which imparts a ¼ wavelength in-plane phase difference (140 nm) between light rays of a predetermined wavelength (e.g. 550 nm) that pass through its fast axis and slow axis in the major plane. In addition, in order to realize the same function as the first segment layer RF5A and second segment layer RF5B, each of the retardation plates BR1 and BR2 has a function of a retardation plate having a negative normal-directional phase difference (e.g. −110 nm) in the normal direction.

With this structure, too, the same function as that of the liquid crystal display device shown in FIG. 1A can be realized. Since the functions of a plurality of retardation plates can be realized by a single retardation plate, the number of components can be reduced, the layer thickness of the device can be deceased, and the reduction in thickness of the device can advantageously be achieved.

In the structure shown in FIG. 1C, the first retardation plate RF1 and first segment RF5A are composed of the single biaxial retardation plate BR1, and the second retardation plate RF2 and second segment RF5B are composed of the single biaxial retardation plate BR2. Alternatively, only the first retardation plate RF1 and first segment RF5A, or the second retardation plate RF2 and second segment RF5B may be composed of the single biaxial retardation plate, and the same function can be realized.

In Modification 2, too, the viewing angle characteristics can be improved without using a high-cost retardation plate.

(Second Embodiment)

The above-described first embodiment is directed to liquid crystal display devices in which a transmissive part is provided in at least a part of the pixel PX of the liquid crystal cell C or in at least a part of the display region DP. The invention, however, is not limited to this embodiment. The same structure is also applicable to, e.g. a liquid crystal display device wherein a reflective layer is provided in at least a part of the pixel PX of the liquid crystal cell C or in at least a part of the display region DP.

Specifically, as shown in FIG. 1D, a circular-polarization-based vertical alignment mode liquid crystal display device according to a second embodiment of the invention is a reflective liquid crystal display device and comprises a circular polarizer/analyzer structure AP and a variable retarder structure VR, which are stacked in the named order. The variable retarder structure VR includes a dot-matrix liquid crystal cell C in which a liquid crystal layer is held between two electrode-equipped substrates. Specifically, this liquid crystal cell C is an MVA mode liquid crystal cell, and a liquid crystal layer 7 is held between an active matrix substrate 14 and a counter-substrate 13. The gap between the active matrix substrate 14 and counter-substrate 13 is kept constant by a spacer (not shown). The liquid crystal cell C includes a display region DP for displaying an image. The display region DP is composed of pixels PX that are arranged in a matrix.

A pixel electrode 10, which is disposed in each pixel PX, includes, as a part thereof, a reflective layer formed of a light-reflective metal material such as aluminum. In the reflective part including the reflective layer, the thickness d of the liquid crystal layer 7 is set at about half the thickness of the transmissive part of the liquid crystal display device according to the above-described first embodiment.

The circular polarizer/analyzer structure AP includes a polarizer plate PL and a uniaxial first retardation plate RF1 that is interposed between the polarizer plate PL and liquid crystal cell C. The polarizer plate PL has a transmission axis and an absorption axis, which are substantially perpendicular to each other in the plane thereof. The first retardation plate RF1 is a uniaxial ¼ wavelength plate that has a fast axis and a slow axis in its plane, which are substantially perpendicular to each other, and provides a phase difference of ¼ wavelength between light rays with a predetermined wavelength (e.g. 550 nm), which pass through the fast axis and slow axis. The first retardation plate RF1 is disposed such that its slow axis forms an angle of about 45° with respect to the absorption axis of the polarizer plate PL.

The liquid crystal display device with this structure includes a first optical compensation layer OC1, which is disposed for optical compensation of the circular polarizer/analyzer structure AP (including the base film of the polarizer plate PL) between the polarizer plate PL and first retardation plate RFl; and a second optical compensation layer OC2, which is disposed for optical compensation of the variable retarder structure VR between the liquid crystal cell C and the first retardation plate RF1.

Specifically, the first optical compensation layer OC1 compensates the viewing angle characteristics of the circular polarizer/analyzer structure AP so that emission light from the circular polarizer/analyzer structure AP may become substantially circularly polarized light, regardless of the direction of emission. The second optical compensation layer OC2 compensates the viewing angle characteristics of the phase difference of the liquid crystal cell C in the variable retarder structure VR (i.e. an optically positive normal-directional phase difference of the liquid crystal layer 7 in the state in which the liquid crystal molecules 8 are aligned substantially vertical to the major surface of the substrate, that is, in the state of black display).

The first optical compensation layer OC1 includes an optically uniaxial second retardation plate (negative A-plate) RF2 which has a refractive index anisotropy of nx≃nz>ny. The second retardation plate RF2 is disposed such that its slow axis is substantially perpendicular to the absorption axis of the polarizer plate PL.

The second optical compensation layer OC2 includes an optically uniaxial third retardation plate (negative C-plate) RF3 which has a refractive index anisotropy of nx≃ny>nz. In the embodiment shown in FIG. 1D, the third retardation plate RF3 is disposed between the liquid crystal cell C and first retardation plate RF1. In the reflective liquid crystal display device, ambient light, which is reflected in the liquid crystal cell C, passes through the third retardation plate RF3 twice. Specifically, ambient light passes through the third retardation plate RF3 at a time of entering the liquid crystal cell C and at a time of being reflected to the outside from the liquid crystal cell C. Thus, the third retardation plate RF3 is configured to have a normal-directional phase difference which corresponds to half the value necessary for compensating the normal-directional phase difference of the liquid crystal cell C. For example, in the case where a normal-directional phase difference of −160 nm is necessary for compensating the normal-directional phase difference of the liquid crystal cell C, the third retardation is configured to have a normal-directional phase difference of −80 nm.

A retardation plate having a refractive index ellipsoid as shown in FIG. 2 is applicable as the first retardation plate RF1. A retardation plate having a refractive index ellipsoid as shown in FIG. 3 is applicable as the second retardation plate RF2. A retardation plate having a refractive index ellipsoid as shown in FIG. 4 is applicable as the third retardation plate RF3.

With the reflective liquid crystal display device including the reflective part, too, the viewing angle characteristics can be improved and the cost can be made lower than in the case of using a biaxial retardation plate.

The first retardation plate RF1 and third retardation plate RF3 may be composed of a single biaxial retardation plate BR2 as shown in FIG. 1C. Even in this case, the same function as the liquid crystal display device shown in FIG. 1D can be realized.

In this second embodiment, the first retardation plate RF1 can be formed of the same material as the first retardation plate RF1 and second retardation plate RF2 which have been described in connection with the first embodiment. In the second embodiment, the second retardation plate RF2 can be formed of the same material as the third retardation plate RF3 and fourth retardation plate RF4 which have been described in connection with the first embodiment. In the second embodiment, the third retardation plate RF3 can be formed of the same material as the fifth retardation plate RF3 which has been described in connection with the first embodiment.

(Third Embodiment)

A circular-polarization-based vertical-alignment-mode liquid crystal display device according to a third embodiment of the invention is a transflective liquid crystal display device, as shown in FIG. 1E, and comprises a circular polarizer structure P, a variable retarder structure VR and a circular analyzer structure A, which are stacked in the named order. The variable retarder structure VR includes a dot-matrix liquid crystal cell C in which a liquid crystal layer is held between two electrode-equipped substrates. Specifically, this liquid crystal cell C is an MVA mode liquid crystal cell, and each pixel is configured to include both a transmissive part and a reflective part.

A pixel electrode 10, which is disposed in each pixel PX, includes, as parts thereof, a reflective electrode 10R formed of a light-reflective material such as aluminum, and a transmissive electrode 10T formed of a light-transmissive material such as ITO. The thickness dl of the liquid crystal layer 7 in the reflective part is set at about half the thickness d2 of the liquid crystal layer 7 in the transmissive part.

The fifth retardation plate RFS is functionally divided into a first segment layer RF5A, which is disposed between the first retardation plate RF1 and the liquid crystal cell C, and a second segment layer RF5B, which is disposed between the second retardation plate RF2 and the liquid crystal cell C. The thickness of the first segment layer RF5A is equal to the thickness of the second segment layer RF5B. For example, if the fifth retardation plate RF5 needs to have a normal-directional phase difference of −160 nm, each of the first segment layer RFSA and second segment layer RF5B is configured to have a normal-directional phase difference of −80 nm. Specifically, reflective light, which is reflected by the reflective part, passes through the second segment layer RF5B twice. Thereby, a desired normal-directional phase difference is imparted to the reflective light. Transmissive light, which passes through the transmissive part, once passes the first segment layer RF5A and also once passes the second segment layer RF5B. Thereby, a desired normal-directional phase difference is imparted to the transmissive light.

In the other structural aspects, the third embodiment is the same as the first embodiment.

With this transflective liquid crystal display device, too, the viewing angle characteristics can be improved, and the cost can be made less than in the case of using the biaxial retardation plate.

A specific example of the present invention will be described below. The main structure of the example is the same as that of the first embodiment shown in FIG. 1A.

### EXAMPLE

In a liquid crystal display device according to the example, an F-based liquid crystal (manufactured by Merck Ltd.) was used as a nematic liquid crystal material with negative dielectric anisotropy for the liquid crystal layer 7. The refractive index anisotropy Δn of the liquid crystal material used in this case is 0.095 (wavelength for measurement=550 nm; in the description below, all refractive indices and phase differences of retardation plates are values measured at wavelength of 550 nm), and the thickness d of the liquid crystal layer 7 is 3.5 μm. Thus, the Δn·d of the liquid crystal layer 7 is 330 nm.

In this example, a uniaxial ¼ wavelength plate (in-plane phase difference=140 nm), which is formed of ZEONOR resin (manufactured by Nippon Zeon Co., Ltd.), is used as the first retardation plate RF1 and second retardation plate RF2.

On the other hand, the back surface (opposed to the liquid crystal cell C) of the film that is used as the second retardation plate RF2 is rubbed, and the rubbed surface is coated with an ultraviolet cross-linking chiral nematic liquid crystal (manufactured by Merck Ltd.) with a thickness of 1.41 μm, which has a refractive index anisotropy Δn of 0.102 and a helical pitch of 0.9 μm. The coated liquid crystal layer is irradiated with ultraviolet in the state in which the helical axis agrees with the normal direction of the film. This liquid crystal polymer layer corresponds to a negative C-plate and functions as the fifth retardation plate RF5. The normal-directional phase difference of the fifth retardation plate RF5, which is thus obtained, is −160 nm.

The first retardation plate RF1 was attached via an adhesive layer, such as glue, such that the first retardation plate RF1 is opposed to the liquid crystal layer 7. In addition, a negative A-plate, which is formed of denatured polycarbonate (manufactured by Nitto Denko), was attached via an adhesive layer, such as glue, immediately on the first retardation plate RF1 as the third retardation plate RF3, and a polarizer plate of SRW062A (manufactured by Sumitomo Chemical Co., Ltd.) was attached as the first polarizer plate PL1 via an adhesive layer, such as glue, immediately on the third retardation plate RF3. The first polarizer plate PL1 is disposed such that the absorption axis thereof intersects at right angles with the slow axis of the third retardation plate RF3. The normal-directional phase difference and in-plane phase difference of the third retardation plate RF3 are 130 nm.

On the other hand, the second retardation plate RF2 having the fifth retardation plate RF5 was attached via an adhesive layer, such as glue, such that the fifth retardation plate RF5 is opposed to the liquid crystal layer 7. In addition, a negative A-plate, which is formed of denatured polycarbonate (manufactured by Nitto Denko), was attached via an adhesive layer, such as glue, immediately on the second retardation plate RF2 as the fourth retardation plate RF4, and a polarizer plate of SRW062; A (manufactured by Sumitomo Chemical Co., Ltd.) was attached as the second polarizer plate PL2 via an adhesive layer, such as glue, immediately on the fourth retardation plate RF4. The second polarizer plate PL2 is disposed such that the absorption axis thereof intersects at right angles with the slow axis of the fourth retardation plate RF4. The normal-directional phase difference and in-plane phase difference of the fourth retardation plate RF4 are 130 nm.

The angle between the transmission axis of each of the first polarizer plate PL1 and second polarizer plate PL2 and the slow axis of each of the first retardation plate RF1 and second retardation plate RF2 is π/4 (rad). Protrusions 12 and slits 11 are arranged such that the orientation direction of liquid crystal molecules at the time when voltage is applied to the liquid crystal layer 7 is parallel or perpendicular to the transmission axes of the first polarizer plate PL1 and second polarizer plate PL2. The absorption axis of the second polarizer plate PL2 and the absorption axis of the first polarizer plate PL1 are disposed to intersect at right angles with each other. Further, the slow axis of the first retardation plate RF1 and the slow axis of the second retardation plate RF2 are disposed to intersect at right angles with each other.

In the liquid crystal display device with this structure, a voltage of 5.0V (at white display time) and a voltage of 1.0V (at black display time; this voltage is lower than a threshold voltage of liquid crystal material, and with this voltage the liquid crystal molecules remain in the vertical alignment) were applied to the liquid crystal layer 7, and the viewing angle characteristics of the contrast ratio were evaluated.

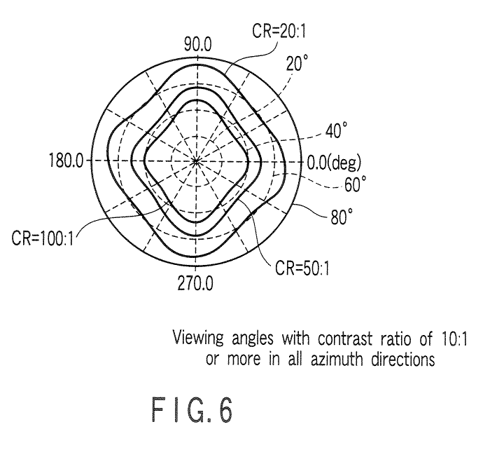

FIG. 6 shows the measurement result. It was confirmed that in almost all azimuth directions, the viewing angle with a contrast ratio of 10:1 or more was ±80° or more, and excellent viewing angle characteristics were obtained. In addition, the transmittance at 5.0V was measured, and it was confirmed that a very high transmittance of 5.0% was obtained.

As has been described above, the present invention provides a novel structure of a liquid crystal display device. This structure aims at preventing a decrease in transmittance, which occurs when liquid crystal molecules are schlieren-oriented or orientated in an unintentional direction in a display mode, such as a vertical alignment mode or a multi-domain vertical alignment mode, in which the phase of incident light is modulated by about ½ wavelength in the liquid crystal layer. This invention can solve such problems that the viewing angle characteristic range is narrow and the manufacturing cost of components that are used is high, in the circular-polarization-based display mode in which circularly polarized light is incident on the liquid crystal layer, in particular, in the circular-polarization-based MVA display mode.

According to the novel structure, like the conventional circular-polarization-based MVA display mode, not only high transmittance characteristics can be obtained, but also excellent contrast/viewing angle characteristics are realized. Moreover, the manufacturing cost is lower than in the circular-polarization-based MVA mode using the conventional viewing angle compensation structure.

The present invention is not limited to the above-described embodiments. At the stage of practicing the invention, various modifications and alterations may be made without departing from the spirit of the invention. Structural elements disclosed in the embodiments may properly be combined, and various inventions can be made. For example, some structural elements may be omitted from the embodiments. Moreover, structural elements in different embodiments may properly be combined.

What is claimed is:

1. A liquid crystal display device which is configured such that a dot-matrix liquid crystal cell, in which a liquid crystal layer is held between two electrode-equipped substrates, is disposed between a first polarizer plate that is situated on a light source side and a second polarizer plate that is situated on an observer side, a uniaxial first retardation plate is disposed between the first polarizer plate and the liquid crystal cell such that a slow axis of the first retardation plate forms an angle of about 45° with respect to an absorption axis of the first polarizer plate, and a uniaxial second retardation plate is disposed between the second polarizer plate and the liquid crystal cell such that a slow axis of the second retardation plate forms an angle of about 45° with respect to an absorption axis of the second polarizer plate, the liquid crystal display device comprising:
a circular polarizer structure including the first polarizer plate and the first retardation plate;
a variable retarder structure including the liquid crystal cell; and
a circular analyzer structure including the second polarizer plate and the second retardation plate,
wherein the variable retarder structure has an optically positive normal-directional phase difference in a black display state,
each of the first retardation plate and the second retardation plate is a ¼ wavelength plate which provides a phase difference of a ¼ wavelength between light rays of a predetermined wavelength that pass through a fast axis and the slow axis thereof,
the circular polarizer structure includes a first optical compensation layer which is disposed for optical compensation of the circular polarizer structure between the first polarizer plate and the first retardation plate, the first optical compensation layer including a third retardation plate with a refractive index anisotropy of nx≃nz>ny, the third retardation plate being disposed such that a slow axis thereof is substantially perpendicular to the absorption axis of the first polarizer plate,
the circular analyzer structure includes a second optical compensation layer which is disposed for optical compensation of the circular analyzer structure between the second polarizer plate and the second retardation plate, the second optical compensation layer including a fourth retardation plate with a refractive index anisotropy of nx≃nz>ny, the fourth retardation plate being disposed such that a slow axis thereof is substantially perpendicular to the absorption axis of the second polarizer plate, and
the variable retarder structure includes a third optical compensation layer which is disposed for optical compensation of the variable retarder structure between the first retardation plate and the second retardation plate, the third optical compensation layer including a fifth retardation plate with a refractive index anisotropy of nx≃ny>nz.

2. The liquid crystal display device according to claim 1, wherein the fifth retardation plate comprises a first segment layer, which is disposed between the first retardation plate and the liquid crystal cell, and a second segment layer, which is disposed between the second retardation plate and the liquid crystal cell.

3. The liquid crystal display device according to claim 2, wherein at least one of a combination of the first segment layer and the first retardation plate and a combination of the second segment layer and the second retardation plate is formed of a single biaxial retardation plate which has such a total optical function as to impart a phase difference of ¼ wavelength between light rays of a predetermined wavelength that pass through a fast axis and a slow axis thereof, and to be equivalent to a biaxial refractive index anisotropy of nx>ny>nz.

4. The liquid crystal display device according to claim 1, wherein the liquid crystal cell has a vertical alignment mode in which liquid crystal molecules in a pixel are aligned substantially vertical to a major surface of the substrate in a voltage-off state.

5. The liquid crystal display device according to claim 4, wherein the liquid crystal cell has a multi-domain vertical alignment mode in which liquid crystal molecules in the pixel are controlled and oriented in at least two directions in a voltage-on state.

6. The liquid crystal display device according to claim 5, wherein an orientation direction of liquid crystal molecules in the pixel in the voltage-on state is controlled to be substantially parallel to the absorption axis or a transmission axis of the first polarizer plate in at least half an opening region of each pixel.

7. The liquid crystal display device according to claim 5, wherein the liquid crystal display device includes at least one of a protrusion for multi-domain control, which is provided in the pixel, and a slit for multi-domain control, which is provided in the electrode.

8. The liquid crystal display device according to claim 5, wherein alignment films, which are subjected to an alignment process for multi-domain control, are provided on those surfaces of the two substrates, which hold the liquid crystal layer.

9. The liquid crystal display device according to claim 1, wherein a combination of the second retardation plate and the fifth retardation plate is formed of a single biaxial retardation plate which has such a total optical function as to impart a phase difference of ¼ wavelength between light rays of a predetermined wavelength that pass through a fast axis and a slow axis thereof, and to be equivalent to a biaxial refractive index anisotropy of nx>ny>nz.

10. The liquid crystal display device according to claim 1, wherein the first retardation plate and the second retardation plate are formed of a resin which is selected from the group consisting of an ARTON resin, a polyvinyl alcohol resin, a ZEONOR resin, a triacetyl cellulose resin and a denatured polycarbonate resin.

11. The liquid crystal display device according to claim 1, wherein the third retardation plate and the fourth retardation plate are formed of one of a norbornene resin, a denatured polycarbonate resin and a discotic liquid crystal polymer.

12. The liquid crystal display device according to claim 1, wherein the fifth retardation plate is formed of one of a chiral nematic liquid crystal polymer, a cholesteric liquid crystal polymer and a discotic liquid crystal polymer.

13. The liquid crystal display device according to claim 1, wherein the liquid crystal cell includes a reflective layer at least in a part of a pixel or at least in a part of a display region.

14. The liquid crystal display device according to claim 1, wherein an in-plane phase difference and an normal-directional phase difference of the third retardation plate and fourth retardation plate are greater than 30 nm and less than 160 nm.

15. The liquid crystal display device according to claim 1, wherein an normal-directional phase difference of the fifth retardation plate is greater than −180 nm and less than −145 nm.

16. A liquid crystal display device including a uniaxial first retardation plate, which is disposed between a dot-matrix liquid crystal cell, in which a liquid crystal layer is held between two electrode-equipped substrates and a reflective layer is provided in each of pixels, and a polarizer plate such that a slow axis of the first retardation plate forms an angle of about 45° with respect to an absorption axis of the polarizer plate, the liquid crystal display device comprising:
a circular polarizer/analyzer structure including the polarizer plate and the first retardation plate; and
a variable retarder structure including the liquid crystal cell,
wherein the variable retarder structure has an optically positive normal-directional phase difference in a black display state,
the first retardation plate is a ¼ wavelength plate which provides a phase difference of a ¼ wavelength between light rays of a predetermined wavelength that pass through a fast axis and a slow axis thereof,
the circular polarizer/analyzer structure includes a first optical compensation layer which is disposed for optical compensation of the circular polarizer/analyzer structure between the polarizer plate and the first retardation plate, the first optical compensation layer including a second retardation plate with a refractive index anisotropy of nx≃nz>ny, the second retardation plate being disposed such that a slow axis thereof is substantially perpendicular to the absorption axis of the polarizer plate, and
the variable retarder structure includes a second optical compensation layer which is disposed for optical compensation of the variable retarder structure between the first retardation plate and the liquid crystal cell, the second optical compensation layer including a third retardation plate with a refractive index anisotropy of nx≃ny>nz.
